(19) United States
(12) Patent Application Publication
(10) Pub. No.: US 2023/0169733 A1
(43) Pub. Date: Jun. 1, 2023

(54) SYSTEM AND METHOD FOR RENDERING OBJECTS IN AN EXTENDED REALITY

(71) Applicant: Flipkart Internet Private Limited, Bengaluru (IN)

(72) Inventors: Varahur Kannan Sai KRISHNA, Bengaluru (IN); Ajay Ponna VENKATESHA, Bengaluru (IN)

(73) Assignee: Flipkart Internet Private Limited, Bengaluru (IN)

(21) Appl. No.: 17/670,989

(22) Filed: Feb. 14, 2022

(30) Foreign Application Priority Data
Dec. 1, 2021 (IN) 202141055733

(51) Int. Cl. G06T 19/00

(52) U.S. Cl. CPC G06T 19/00; G06T 2200/24; G06T 2210/08; G06T 2200/16

(57) ABSTRACT

A system and method for rendering objects in a virtual/augmented reality environment. The system includes a processor and a memory including a set of instructions. An execution of the set of instructions may cause the processor to render a user environment representative of a 3-Dimensional (3D) map and 3D space position data. The user environment may be rendered on a display device of a user by using a rendering engine of the system. The processor may configure a responsive extended reality (XR) zone within the rendered user environment through a zone engine. The XR zone may be adapted to provision contextually aware information pertaining to one or more virtual features, data, and objects that are dynamically calibrated based on real-time changes in parameters associated with the user environment.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Extended Reality (XR) refers to a combined environment involving real and/or virtual representations that are rendered using computer technology and devices such as wearables. The term XR may be considered to be an umbrella term that majorly include Augmented Reality (AR), Virtual Reality (VR), Mixed Reality (MR). The combined environment in the XR may require generation of synthetic/digital elements or information based on features of real world environmental. The generated XR environment may be used for several applications, such as, for example, enterprise productivity, entertainment purpose such as gaming, watching media and social interaction, education and training purposes such as simulation and practice-based learning, immersive field trips, hands on or interactive labs, guided feedback learning and other such applications.

The XR environment generation may require consistency of visual information as well as contextual awareness of the real world environment and corresponding dynamic changes. However, the conventional or known XR generation techniques may lack responsiveness. This is mainly because the conventional XR generation techniques may be localized to pre-defined user environment and may offer a standard size, dimension or attribute of objects in the XR environment. This may lead to a poor user experience due to mismatch between the real world environment and the object in the XR environment, thereby resulting in sub-optimal user engagement.

Therefore, it is apparent from the aforementioned problems, that there exists a need to provide for a system and a method that provides for an automated mechanism for rendering objects in a virtual/augmented reality. Further, there also exists a need for a frame-work that may enable a dynamic calibration in real time based on changes in environmental parameters to commensurate the dynamic changes to space positions of objects in the XR environment.

### SUMMARY

This section is provided to introduce certain objects and aspects of the present invention in a simplified form that are further described below in the detailed description. This summary is not intended to identify the key features or the scope of the claimed subject matter. In order to overcome at least a few problems associated with the known solutions as provided in the previous section, an object of the present invention is to provide a technique that may generate a responsive rendering technique for virtual/augmented reality based on changes in real environment of a user.

It is another object of the present invention to provide a system and a method that may generate extended zones based on contextual awareness such that the zones may be dynamically calibrated based on real time changes in a real world environment for an enriched user experience.

It is another object of the present invention to provide a system and a method that may enable calibration of objects in the XR zone/environment based on sizing, representation, and visualization in a responsive manner.

It is yet another object of the present invention to provide a system and a method to provide a frame-work for defining 2D content representations that can be utilized into 3D spatial data and objects in an XR zone/environment.

In view of the aforesaid objects of the present invention, a first aspect of the present invention relates to a method for rendering objects in a virtual/augmented reality environment. The method includes a step of rendering, on a display device of a user, a user environment representative of a 3-Dimensional (3D) map and 3D space position. The rendering may be performed using a rendering engine of the system. The method includes a step of configuring a responsive extended reality (XR) zone within the rendered user environment through a zone engine. The XR zone may be adapted to provision contextually aware information pertaining to one or more virtual features, data, and objects that may be dynamically calibrated based on real-time changes in parameters associated with the user environment.

Another aspect of the disclosure relates to a system for rendering objects in a virtual/augmented reality environment. The system includes a processor and a memory including a set of instructions. An execution of the set of instructions may cause the processor to render a user environment representative of a 3-Dimensional (3D) map and 3D space position data. The user environment may be rendered on a display device of a user by using a rendering engine of the system. The processor may configure a responsive extended reality (XR) zone within the rendered user environment through a zone engine. The XR zone may be adapted to provision contextually aware information pertaining to one or more virtual features, data, and objects that are dynamically calibrated based on real-time changes in parameters associated with the user environment.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components or circuitry commonly used to implement such components.

FIG. 1A illustrates an exemplary system 100 for rendering objects in a virtual/augmented reality environment, according to an example embodiment of the present disclosure.

FIG. 1B illustrates an exemplary system 100 for rendering objects in a virtual/augmented reality environment, according to an example embodiment of the present disclosure.

FIG. 2A illustrate an exemplary representation 200 depicting elements involved in object dimensioning for rendering objects in a virtual/augmented reality environment, according to an example embodiment of the present disclosure.

FIG. 2B illustrate an exemplary representation 202 depicting elements involved in composing object resolution for rendering objects in a virtual/augmented reality environment, according to an example embodiment of the present disclosure.

FIG. 2C illustrate an exemplary representation 204 depicting elements involved in facilitating active Field of View (FOV) for rendering objects in a virtual/augmented reality environment, according to an example embodiment of the present disclosure.

FIG. 2D illustrate an exemplary representation 206 depicting elements involved in access control in a virtual/augmented reality environment, according to an example embodiment of the present disclosure.

FIG. 2E illustrate an exemplary representation 208 depicting elements pertaining to ambisonic awareness in a virtual/augmented reality environment, according to an example embodiment of the present disclosure.

FIG. 2F illustrate an exemplary representation 210 depicting elements that influence throughput of data in a virtual/augmented reality environment, according to an example embodiment of the present disclosure.

FIG. 2G illustrate an exemplary representation 212 depicting elements associated with human interaction in a virtual/augmented reality environment, according to an example embodiment of the present disclosure.

FIG. 2H illustrate an exemplary representation 214 depicting elements associated with component behaviour in a virtual/augmented reality environment, according to an example embodiment of the present disclosure.

FIG. 2I illustrate an exemplary representation 216 depicting elements pertaining to fonts in a virtual/augmented reality environment, according to an example embodiment of the present disclosure.

FIG. 2J illustrate an exemplary representation 218 depicting elements associated with spatial awareness in a virtual/augmented reality environment, according to an example embodiment of the present disclosure.

FIG. 2K illustrate an exemplary representation 220 depicting elements related to locomotion requirements for rendering objects in a virtual/augmented reality environment, according to an example embodiment of the present disclosure.

FIG. 3 illustrates a flow diagram 300 depicting steps involved in rendering objects in a virtual/augmented reality environment, according to an example embodiment of the present disclosure.

FIG. 4 illustrates a hardware platform 400 for implementation of the disclosed system, according to an example embodiment of the present disclosure.

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. The terms “a” and “a” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being performed or considered.

As used herein, “connect”, “configure”, “couple” and its cognate terms, such as “connects”, “connected”, “configured” and “coupled” may include a physical connection (such as a wired/wireless connection), a logical connection (such as through logical gates of semiconducting device), other suitable connections, or a combination of such connections, as may be obvious to a skilled person. As used herein, “send”, “transfer”, “transmit”, and their cognate terms like “sending”, “sent”, “transferring”, “transmitting”, “transferred”, “transmitted”, etc. include sending or transporting data or information from one unit or component to another unit or component, wherein the content may or may not be modified before or after sending, transferring, transmitting.

In the following description, for the purposes of explanation, various specific details are set forth in order to provide a thorough understanding of embodiments of the present invention. It will be apparent, however, that embodiments of the present invention may be practiced without these specific details. Several features described hereafter can each be used independently of one another or with any combination of other features. An individual feature may not address any of the problems discussed above or might address only one of the problems discussed above. Some of the problems discussed above might not be fully addressed by any of the features described herein. Example embodiments of the present invention are described below, as illustrated in various drawings in which references such as numerals refer to the same parts throughout the different drawings.

The present invention provides a solution to the aforementioned problems in the form of a system and a method for rendering objects in a virtual/augmented reality environment. The solution is more particularly related to implementing dynamic responsiveness in the virtual/augmented reality environment based on the changes in the real-world environment. This enables improvement in naturalistic representation of virtual objects or information based on the parameters around the user. To achieve this, the system facilitates to render a user environment on a display device of a user. The user environment may be representative of a 3-Dimensional (3D) map and 3D space position. The rendering may be performed by a rendering engine of the system. The system may facilitate to configure a responsive extended reality (XR) zone within the rendered user environment through a zone engine. The XR zone may be adapted to provision contextually aware information pertaining to one or more virtual features, data, and objects that may be dynamically calibrated based on real-time changes in parameters associated with the user environment. The implementation of the present system and method enables to impart consistency of visual information as well as contextual awareness of presented information in the user environment. Thus, by making content more contextually aware, the rendering engine may utilize available information to generate the XR zone for effective dynamic and responsive change in the virtual features, data, and objects. The system and method of the present disclosure may be applied to several applications that involve implementation of virtual/augmented reality environment for presentation of information to a user. For example, the present invention may be applied for education and training purposes such as, for example, simulation and practice-based learning, immersive field trips, hands on/interactive labs, guided feedback based and other such applications. Another example may include entertainment applications such as, for example, gaming, watching media, social interaction, and other such applications. However, one of ordinary skill in the art will appreciate that the present disclosure may not be limited to such applications. The system may also be integrated with other tools for implementation in facilitating enterprise productivity tasks such as, for example, writing documents, editing images, checking lists. Several other applications/advantages may be realized.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes”, “has”, “contains” and other similar words are used in either the detailed description or the claims, such terms are intended to be inclusive in a manner similar to the term “comprising” as an open transition word.

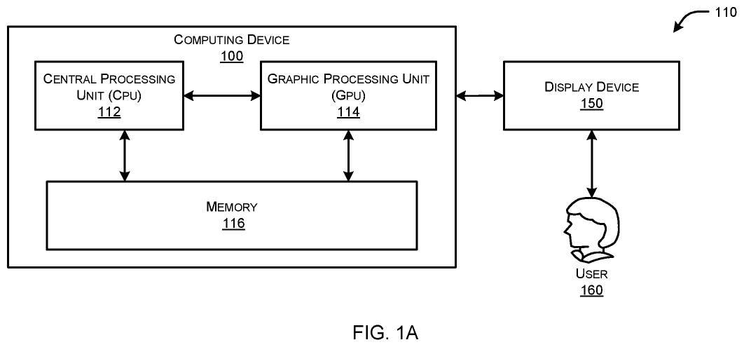

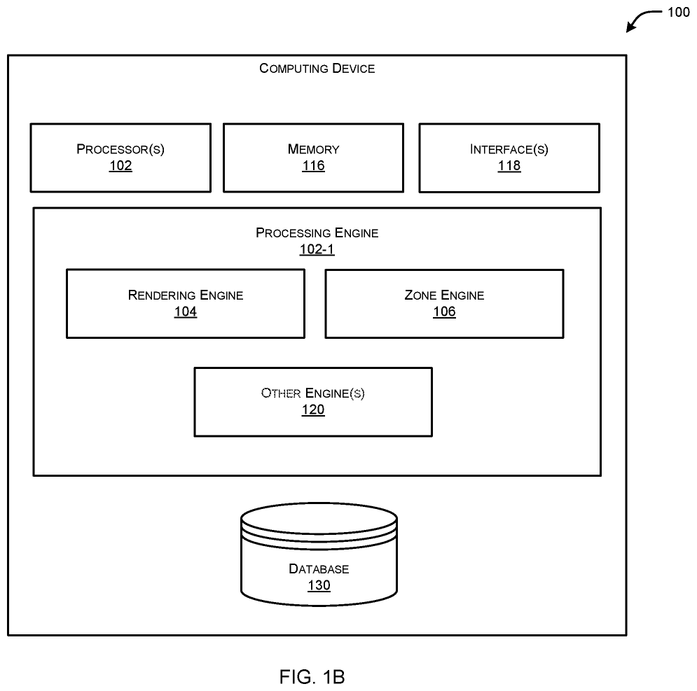

FIG. 1A illustrate an exemplary representation of a system 110 for rendering objects in a virtual/augmented reality environment, according to an example embodiment of the present disclosure. As illustrated, the system 110 may include a computing device 100. The computing device 100 may include a central processing unit (CPU) 112, a graphics card including a graphics processing unit (GPU) 114, and a memory 116. The CPU 112 may be implemented in circuitry and may include single processors, or multiple processors to execute a computer graphics generating program to configure the XR zone. The CPU 112 may be coupled to the GPU 114 to perform rendering objects in the virtual/augmented reality environment. The CPU 112 and the GPU 114, in association with the memory 116 may facilitate the processor(s) to render a user environment representative of a 3-Dimensional (3D) map and 3D space position data. For example, the 3D map and the 3D space position data may enable the system to obtain details about a framework/boundary of real world environment and corresponding real world objects within the boundary to render the user environment. The processor may further configure a responsive extended reality (XR) zone within the rendered user environment. The output of the computing device 100 may be displayed on a display device 150 of a user 160. In an example embodiment, the display device 150 may include or may be associated with a viewing device to experience and/or view the virtual/augmented reality environment and the corresponding XR zones generated by the system. For example, the viewing device may be a virtual/augmented reality headset device including a consolidated or separate display for left and right eyes of the user 160. Several other display devices/viewing devices may be used. The uniqueness of the system lies in the generation of XR zone that may be adapted to provision contextually aware information. This may pertain to one or more virtual features, data, and objects that may be dynamically calibrated based on real-time changes in parameters associated with the user environment. The XR zone may include at least one virtual object, and may be associated with a space within the user environment that defines boundary of the space. The at least one virtual object may be presented to a user by one or more real world environmental points of interest. In an example embodiment, the at least one virtual object may be a 3D object that may be selected by the user 160 based on one or more real environmental features. In an example embodiment, the calibration may be performed with respect to at least one of sizing, representation, and visualization in a responsive manner. These aspects may define the objects and their attributes (such as, for example, dimensions, resolution, size, visibility and other such aspects). The computing device 100 render the objects in the XR zones through local rendering and/or cloud based rendering depending on the requirements of corresponding application. In an example embodiment, the computing device 100 may generate the 3D objects in real time or may retrieve files/data pertaining to 3D object from cloud storage. For example, the cloud based retrieval may be performed as a spatial mesh based on previously scanned data of real-world environment, which are further processed to generate responsive XR zones. The behaviour of the at least one virtual object/3D object with respect to at least one of dimension, properties, and attributes, may be controlled by criteria set by the system. The criteria may enable to assess if the system generated object may be qualifying or satisfying the required criteria for the XR zone. Based on this, the calibration may be performed dynamically to assess if attributes governing the virtual features, the data, and the objects enable real-time changes to provision the contextually aware information. For example, the user 160 may wear a virtual reality headset device and may move from one location to the other, in which case the environment boundary may keep extending and hence the system may need to be contextually aware to provide responsive change in the XR zone based on the real-time changes. In an example embodiment, multiple XR zones may be configured within the user environment, which may require the dynamic calibration for the responsive change.

The computing device 100 may be a hardware device/including processors executing machine readable program instructions to facilitate rendering objects in a virtual/augmented reality environment. Execution of the machine readable program instructions by the processor may enable the proposed system to facilitate rendering objects in the virtual/augmented reality environment. The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processors. The processor may include, for example, microprocessors, microcomputers, microcontrollers, digital signal processors, central processing units, state machines, logic circuits, and/or any devices that manipulate data or signals based on operational instructions. Among other capabilities, processor may fetch and execute computer-readable instructions in a memory operationally coupled with system 100 for performing tasks such as data processing, input/output processing, rendering, configuring XR zone and/or any other functions. Any reference to a task in the present disclosure may refer to an operation being or that may be performed on data.

The display device 150 may include or may be associated with devices, for example, a video game console, a personal computer, smart phone, tablet, virtual/augmented goggles/headset, and other devices enabling execution of three-dimensional (3D) graphics program and/or display of the outcome of the execution. The computing device 100 may execute a set of executable instructions for configuring the XR zone and the dynamic calibration. The set of executable instructions may include/pertain to an application, such as, for example, graphic user interface (GUI) application, a computer-aided design program for engineering or artistic applications, a video game application, other virtual reality (VR) application (VR video game), an augmented reality (AR) application and other such applications. In an example embodiment, the set of executable instructions may also enable to send a viewpoint data representing a user's viewpoint pertaining to the one or more real environmental features corresponding to the user environment, which may be determined using one or more additional accessories. For example, the accessories may include external cameras, accelerometers, gyroscopes, sensors, motion sensors, and other such accessories. In an example embodiment, the data pertaining to the one or more real environmental features may be sent to GPU 114 thorough a graphics Applications Programming Interface (API) and a GPU driver. Further, in an example embodiment, the display device 150 may be either backlit through, for example, a smartphone or a near-eye head mounted display (HMD) with a field of view that may be supported by a processing equipment (computing device 100) and a communication service (such as via short range communication or network based communication). The overall implementation enables to map, render and store 3D representation of the real world environment as well as 3D space positions for the objects in the XR zone. In an example embodiment, the system may also enable to build two-dimensional (2D) content representations and to utilize into 3D spatial data and objects in the XR zone. In a declared spatial or XR zone, computer-generated features may include, for example, the 3D objects, user interface components and volumetric 2D multimedia. The overall system provides a way for adaptively configuring a responsive XR zone within the user environment that assists in providing information for the virtual features, data and objects to be sized, represented and visualized in a responsive manner, and not incorrect to the localization of the user environment. The system also enables to adaptively configure the needed number of responsive XR zones within the user environment. The user environment that is being identified in 3D mapping may serve as a canvas upon which multiple segments (responsive XR zones) may be generated with compatibility criteria for the zone creation, using the 3D map and the 3D space position data in the user environment.

FIG. 1B with reference to FIG. 1A, illustrates an overview of the computing device 100 for rendering objects in a virtual/augmented reality environment, according to an example embodiment of the present disclosure. As illustrated in FIG. 1B, the computing device 100 may include one or more processor(s) 102. The processor 102 may include a rendering engine 104 and a zone engine 106. The processor may be coupled with memory 116. The memory 116 may store instructions which when executed by the one or more processors may cause the system to perform the steps involved in the rendering of objects in virtual/augmented reality environment. The one or more processor(s) 102 may be implemented as one or more microprocessors, microcomputers, microcontrollers, digital signal processors, central processing units, logic circuitries, and/or any devices that process data based on operational instructions. Among other capabilities, the one or more processor(s) 102 may be configured to fetch and execute computer-readable instructions stored in the memory 116. The memory 116 may be configured to store one or more computer-readable instructions or routines in a non-transitory computer readable storage medium for executing rendering of the virtual/augmented environment. In an embodiment, the instructions or routines may be fetched and executed to create or share data packets over a network service. The memory 116 may include any non-transitory storage device including, for example, volatile memory such as RAM, or non-volatile memory such as EPROM, flash memory, and the like.

In an embodiment, the computing device 100 may include an interface(s) 118. The interface(s) 118 may include a variety of interfaces, for example, interfaces for data input and output devices, referred to as I/O devices, storage devices, and the like. The interface(s) 118 may facilitate communication of the computing device with the display device or virtual/augmented reality device. The interface(s) 118 may also provide a communication pathway for one or more components of the computing device 100. Examples of such components include, but are not limited to, processing engine(s) 102-1 and a database 130.

The processing engine(s) 102-1 may be implemented as a combination of hardware and programming (for example, programmable instructions) to implement one or more functionalities of the processing engine(s) 102-1. In examples described herein, such combinations of hardware and programming may be implemented in several different ways. For example, the programming for the processing engine(s) 102-1 may be processor executable instructions stored on a non-transitory machine-readable storage medium and the hardware for the processing engine(s) 102-1 may comprise a processing resource (for example, one or more processors), to execute such instructions. In the present examples, the machine-readable storage medium may store instructions that, when executed by the processing resource, implement the processing engine(s) 102-1. In such examples, the computing device 100 may include the machine-readable storage medium storing the instructions and the processing resource to execute the instructions, or the machine-readable storage medium may be separate but accessible to the computing device 100 and the processing resource. In other examples, the processing engine(s) 102-1 may be implemented by electronic circuitry.

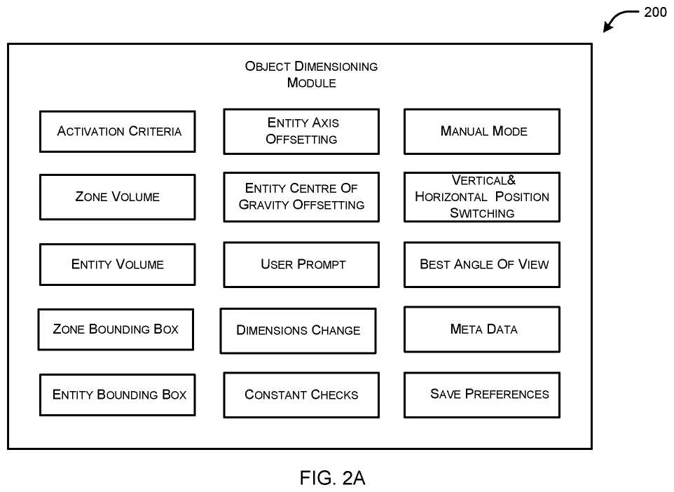

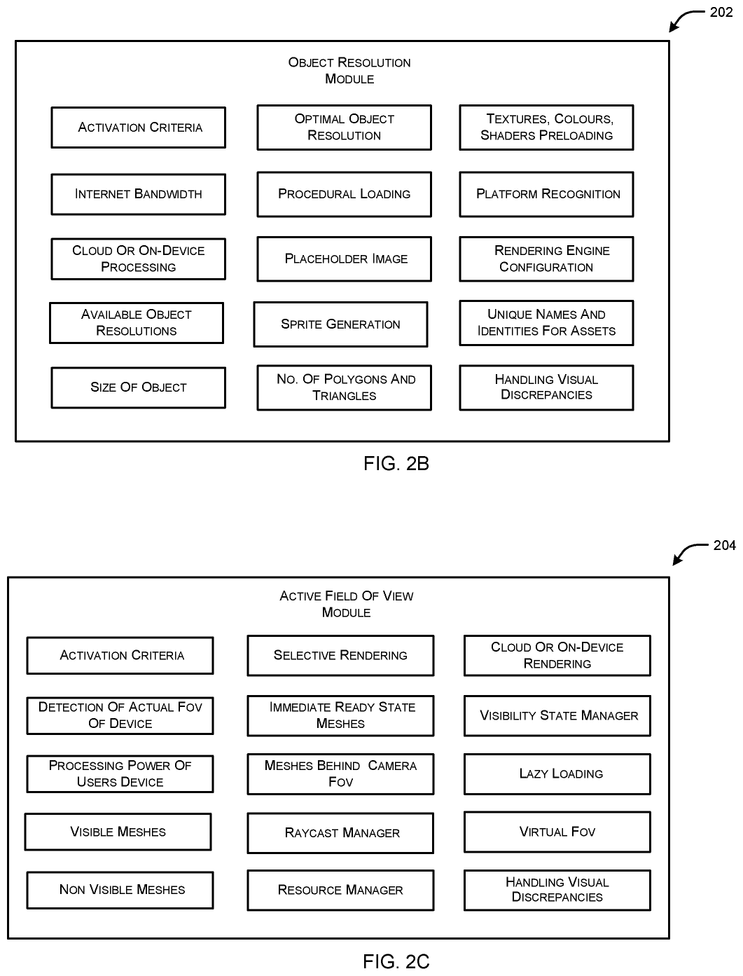

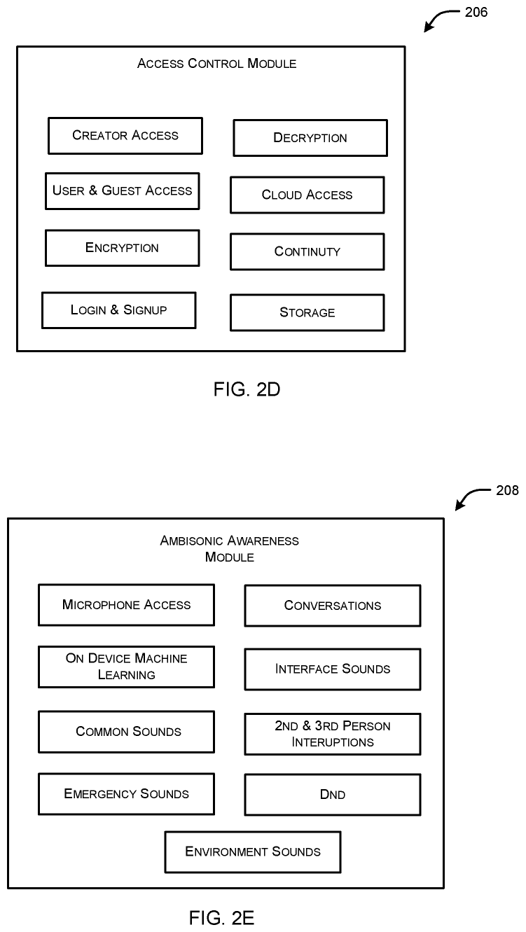

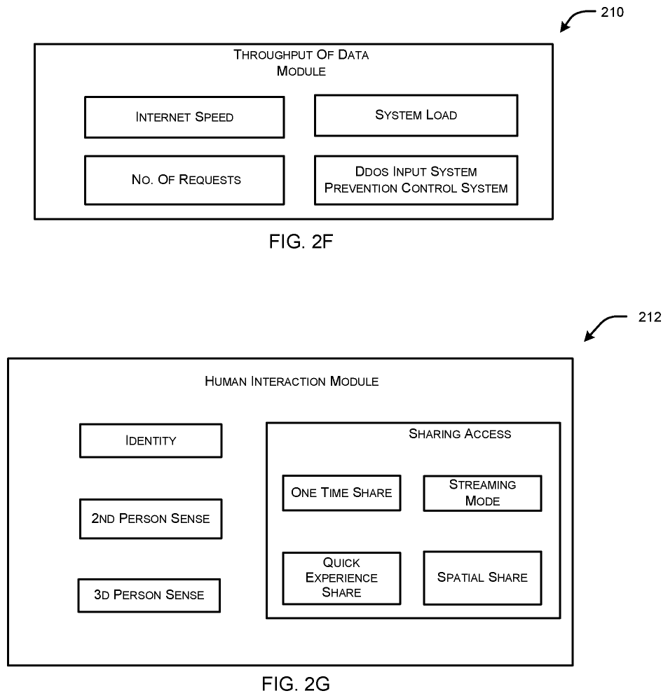

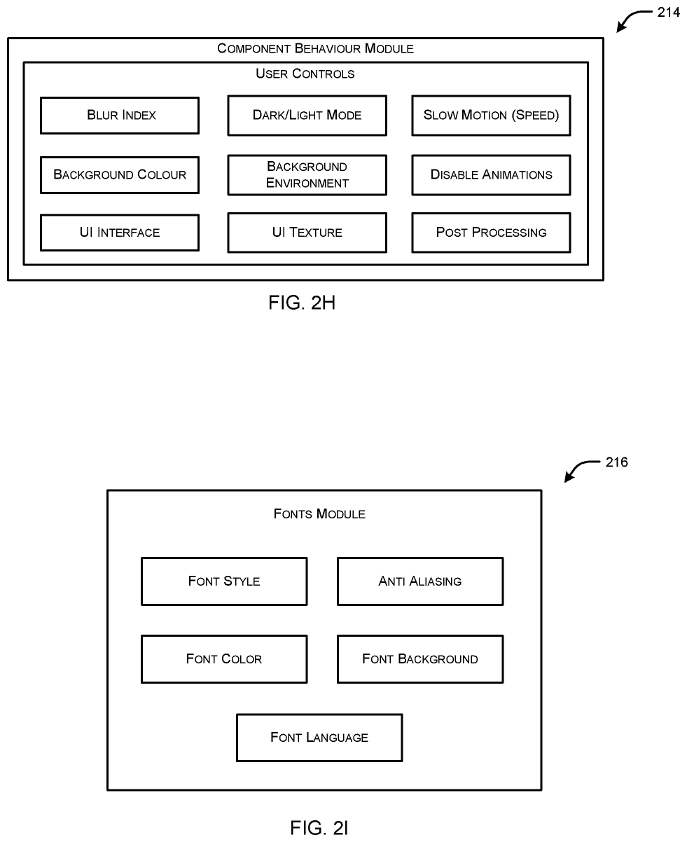

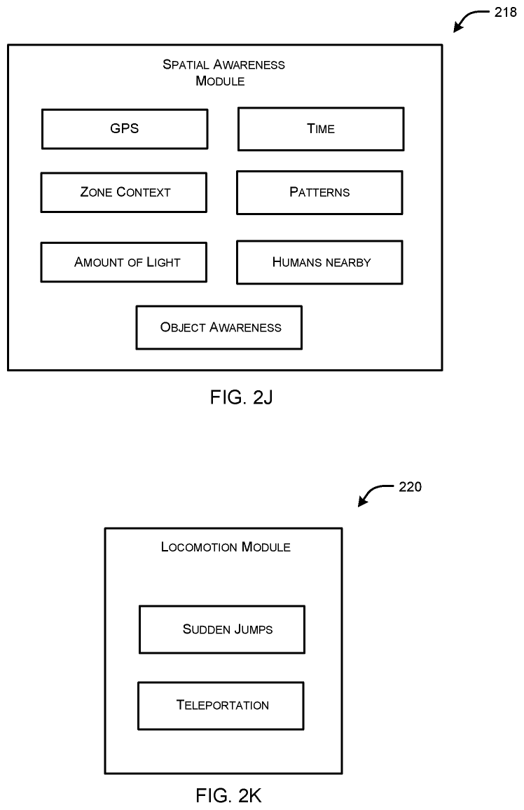

The processing engine 102-1 may include one or more engines such as the rendering engine 104, the zone engine 106 and other engines 120. In an embodiment, the pre-screening engine. The rendering engine 102 may enable to render a user environment representative of a 3-Dimensional (3D) map and 3D space position data. Further, the zone engine 106 may configure a responsive extended reality (XR) zone. The XR zone may be configured within the rendered user environment. In an embodiment, the XR zone may be adapted to provision contextually aware information pertaining to one or more virtual features, data, and objects. In an example embodiment, the one or more virtual features, data, and objects may be dynamically calibrated based on real-time changes in parameters associated with the user environment. The XR zone may include at least one virtual object, and may be associated with a space within the user environment that defines boundary of the space. The behaviour of the at least one virtual object with respect to at least one of dimension, properties, and attributes, may be controlled by criteria set by the zone engine 106. The other engines 120 may facilitate to perform the dynamic calibration based on the one or more attributes. For example, the other engines 120 may be associated with modules (described in FIG. 2A through FIG. 2K) that may enable to calibrate the virtual features, the data, and the objects in the XR zone based on attributes including at least one of object dimensioning, object resolution, active field of view, ambisonic awareness, throughput of the data, access control of the object, human interaction handoff, and component behaviour.

In order to configure the XR zone within the rendered user environment, the system may enable adapting the XR zone to provision contextually aware information pertaining to the one or more virtual features, data, and objects. In an example embodiment, the virtual features, the data, and the objects in the XR zone may be governed based on attributes. For example, object dimensioning based attributes may enable positioning of 3D objects in a spatial interaction medium with suitable adjustments to size the objects for efficient viewing. In another example, object resolution based attributes may enable adjustment of resolution of the 3D objects based on bandwidth availability. In another example, active field of view based attributes may adjust desired field of view based on at least one of a size of the user environment, actual field of view, meshes that are visible to camera, and memory parameters. In another example, ambisonic awareness based attributes may enable adjustment of the XR zone based on at least one of audio/video parameters, intended context of the environment, and desired ambience for the XR zone. In another example, access control of the object may enable access to the virtual object session on a plurality of devices. These attributes and other parameters associated with the user environment facilitating dynamic calibration may be clear in view of the following figures and description.

The object dimensioning proves to be very crucial in providing relative size based adjustments of objects and may impart enhanced visual effects by enabling effective positioning of the objects. An example of existing challenge in obtaining improved sizing may include a scenario wherein an object may seem to be significantly large in size relative to the viewing space or the viewing space may be significantly larger than the object. The object dimensioning may thus pose a characteristic advantage that may enable representation of objects in XR systems such as for example, augmented reality based on the alteration of size, scale and dimensions of 3D objects for a more responsive behaviour. FIG. 2A illustrate an exemplary representation 200 depicting elements involved in object dimensioning for rendering objects in a virtual/augmented reality environment, according to an example embodiment of the present disclosure. The processor 102 (of FIG. 1B) may include a sub-system or object dimensioning module 200 (as shown in FIG. 2A) that may facilitate object dimensioning to enable positioning 3D objects in a spatial interaction medium with suitable adjustments to the size of the 3D object for comfortable or easy viewing. As illustrated in FIG. 2A, the object dimensioning module 200 may include various sub-modules for various elements that may be associated with the object dimensioning function. In an example embodiment, the object dimensioning module 200 may include a sub-module for activation criteria. The activation criteria may define a list of rules/conditions in which the object dimensioning may be required. For example, in one scenario, the 3D objects in the XR zone of the user environment may involve a drastic change in position of the 3D object. In this case, the size of the object may also required to be changed to suit the dimensions based on the change in position. For example, an object moving away from a specific position is expected to look smaller than pre-defined size and an object moving away from a specific position is expected to look larger than a pre-defined size. The sub-module for activation criteria may identify a need for activation of the object dimensioning module 200, based on the relative change in position and size of the 3D object.

The object dimensioning module 200 may include one or more sub-modules for performing size/orientation adjustments such as, for example, adjustments in dimensions, axis, center of gravity, dimensions, angle of view, and other such changes. For example, the object dimensioning module 200 may include a sub-module for dimensions change for modifying the 3D position and/or orientation. In another example, the object dimensioning module 200 may include a sub-module for adjusting/entity axis offsetting, which may allow modification in the axis of the 3D object. Another sub-module may enable to adjust entity center of gravity and/or to obtain vertical or horizontal position switching. These sub-modules may be crucial for the system to perform dynamic and responsive changes in a scenario that requires a dynamic change in the axis/orientation/position of the 3D object. The other adjustments may include attaining best angle of view, visibility distance and other such aspects. For example, to obtain an effective representation of the 3D objects, the object dimensioning module 200 may enable sizing of the 3D objects based on general visibility of users, for example, between 0.5 meter to 20 meter and/or around 30 degree of viewing angle. In another example, the object dimensioning module 200 may consider factors such as, for example, zone volume, entity volume or volume of the 3D object. The object dimensioning module 200 may also include sub-modules for generating a bounding box around a zone (to define a XR zone) and/or around an entity or a 3D object. The object dimensioning module 200 may prioritize an available XR zone medium (in the user environment) including the spatial interaction medium for dynamic sizing. In the instant example, the object dimensioning module 200 may readjust 1:1 scale of 3D object to fit into the XR zone across virtual reality/augmented reality. This may be achieved by defining the XR zone and utilizing the defined spatial interaction medium to map the bounding box around the 3D object such that the user may be presented with a resized size of the object that may be in visual synchronization with the user environment. Based on the defined XR zone and the sizing of the 3D object as per the bounding box, the object dimensioning module 200 may recalibrate key parameters of the 3D object such as, for example, erroneous axis, displaced center of origin, or other such parameters. In an example embodiment, the object dimensioning module 200 may include a sub-module to control one or more aspects of the object dimensioning through a manual mode or based on a user prompt. For example, the user may be further presented with a view to enable manual override and/or readjustment of partial/complete dimensioning specifics. In an example embodiment, the object dimensioning module 200 may also include sub-modules system that may also allow a user to perform constant check or monitoring and/or to save specific preferences or customizations in the form of a metadata associated with the user. In an example embodiment, the user may save the metadata on a hardware device and/or a cloud based service/platform.

The object resolution may be another important attribute for enabling adjustment of resolution of the 3D objects based on bandwidth availability. FIG. 2B illustrate an exemplary representation 202 depicting elements involved in composing object resolution for rendering objects in a virtual/augmented reality environment, according to an example embodiment of the present disclosure. The processor 102 (of FIG. 1B) may include a sub-system or object resolution module 202 (as shown in FIG. 2B) that may facilitate to attain appropriate resolution of the 3D objects in the XR zone. As illustrated in FIG. 2A, the object resolution module 202 may include various sub-modules for various elements that may be associated with the object resolution function. In an example embodiment, the object resolution module 202 may include a sub-module for activation criteria. The activation criteria may define a list of rules/conditions that may be satisfied to obtain an improved/acceptable object resolution. For example, as the 3D object usually is a large filetype, it often requires a capable device, strong network connectivity and in the case of augmented reality, it also requires a well-lit environment. In the absence of any of these key requirements, the resolution or visual fidelity of the 3D object may present a subpar user experience to the viewer. Therefore, it becomes necessary to make appropriate tradeoffs between visual quality, performance, device fidelity and bandwidth availability to present the best experience to the user without additional work. The sub-module for activation criteria may identify a need for activation of the object resolution module 202 if the resolution of the 3D are not as per the requirements. The object resolution module 202 may include a sub-module for controlling aspects pertaining to internet bandwidth/bandwidth availability. For example, this sub-module may poll the active socket for available throughput for downloading/streaming 3D data to the user. Further, the object resolution module 202 may include a sub-module for controlling aspects pertaining to cloud or on-device processing. For example, in the absence of a stable connection, there may be a need for dual mode of optimization performed on the cloud, and on the device. In cloud based optimization, an uploaded 3D object may be passed through this sub-module to automatically be decimated on mesh counts with minimal loss to visual fidelity. This brings the size of the 3D object down by a significant extent. Depending on the throughput of connectivity, the appropriate mesh resolution is represented to the user. On suitable connections with low latency such as, for example, 5G mm waves, the sub-module may default to a load on demand based streaming workflow for the 3D objects/data. Further, the object resolution module 202 may include a sub-module for controlling aspects pertaining to sprite generation. The term “sprite generation” pertains to reduction in bandwidth while retrieving an image/file from a server to enable speed up in page loading time and may be performed by consolidating static images into a single file such that the generated sprite may have good resolution even in case of enlarged/blurry images. The sub-module for sprite generation may enable one or more aspects related to the sprite generation. For example, the 3D object may be in process of loading or in case of a failed state of the 3D object, the streaming workflows may be provided with an image sprite based fallback for representing the loading state or buffer state till the system readjusts to showcase the 3D information on visible line of sight. Further, the object resolution module 202 may include a sub-module to provide a device of the user with textures, colors and shaders for of varying degrees of visual reliability to 3D object or XR zone based on the performance of the device and the availability/bandwidth of the network. The object resolution module 202 may also include sub-module(s) for other aspects related to resolution. For example, the object resolution module 202 may enable to check available object resolution, evaluate size of the 3D object, assess and/or configure optimal object resolution, perform procedural loading, identify number of polygons and triangles, handle visual discrepancies, assign unique names and identities to assets (3D objects pertaining to characters/entity), manage placeholder image, render engine configuration and platform recognition. Various other aspects related to object resolution may be managed by the object resolution module 202.

Another important attribute may include active field of view that may enable to adjust desired field of view based on at least one of a size of the user environment, actual field of view, meshes that are visible to camera, and memory parameters. FIG. 2C illustrate an exemplary representation 204 depicting elements involved in facilitating active Field of View (FOV) for rendering objects in a virtual/augmented reality environment, according to an example embodiment of the present disclosure. The processor 102 (of FIG. 1B) may include a sub-system or active FOV module 204 (as shown in FIG. 2C). As illustrated in FIG. 2C, the active FOV module 204 may include sub-modules for various elements that may be associated with the active FOV for adjustment of FOV in XR zone. In an embodiment, the active FOV module 204 may include a sub-module for activation criteria. The activation criteria may define a list of rules/conditions in which the active FOV may be required to be adjusted. In an example embodiment, the activation criteria may be determined by the amount of space in a scene that a user may be experiencing or the size of the user environment. For example, considering size of the user environment as the main criteria, if the scene includes a room sized one area/environment with just a limited number of simple objects (with not much complexity) then the active FOV may not be required to be adjusted. The sub-module for activation criteria may identify a need for activation of the active FOV module 204 if, for example, the scene includes large number of objects with complex shapes in which active FOV may need to be adjusted.

The active FOV module 204 may include a sub-module for controlling aspects such as detection of FOV of a user device. The sub-module may enable iterations by using varying techniques for better precision of detection based on active FOV as the criterion. For example, the sub-module may detect the actual FOV of the device by two techniques such as, for example, one by getting via a native system API and another by calculating itself by sending rays and seeing for the camera, such that actual FOV of the device is precisely computed. The active FOV module 204 may include a sub-module for evaluating processing power of the user device in adjusted active FOV of the device. For example, the processing power of the user device may be taken into account and an optimal decision is made whether or not to adjust active FOV.

The active FOV module 204 may include a sub-module for identifying meshes that may be visible or invisible. The term “mesh” corresponds to collection of vertices, edges and faces that describe shape of the 3D object. This sub-module may enable to associate an identity with the meshes. For example, the sub-module may identify the meshes that are visible to the FOV of the device (visible meshes) and the meshes that are not visible (non-visible meshes or meshes behind FOV) and may tag them accordingly. After an initial round of this detection may be completed, the sub-module may render only the meshes that are visible, while not rendering the meshes that are not visible. The active FOV module 204 may include a sub-module to facilitate “immediate ready state meshes” that may enable to mark another set of meshes in ready state which are next to proximity of the visibility. Further, the active FOV module 204 may include a sub-module that may act as a visibility state manager to identify the meshes that are behind the camera and not seen by the user such that the meshes may not be rendered unless they are part of a ready state tag. Further, the active FOV module 204 may include a sub-module that may consider the memory parameters as an important criteria during active FOV rendering. This sub-module may act as a raycast manager, resource manager, and/or may enable lazy loading, cloud/on-device rendering and other such aspects. For example, the raycast manager may be executed in the background to keep track of all the raycast activations and corresponding disposing so that the memory consumption is limited as otherwise, raycasting is known to consume huge amount of resources. The term raycasting refers to 3D solid modelling and image rendering technique, in which virtual light rays may be “cast” or “traced” on path from the focal point of a camera through each pixel in the camera sensor to determine what is visible along the ray in the 3-D scene. Further, the resource manager may handle and manage resources to identify the resources that are needed, not needed such that to be disposed whenever not needed. Furthermore, the sub-module for cloud/on-device rendering may identify a need for rendering to be done using cloud service or on the user device. The cloud based rendering may include techniques such as, for example, server side rendering in which code runs on the server whereas client end receives simplified pure HTML. The active FOV module 204 may also enable to manage visual identity of the 3D objects through a virtual FOV thereby ensuring that the objects may not be lost anywhere from a given XR zone during active FOV based rendering and/or to perform a mitigation if the 3D object is lost from the FOV.

Another important attribute may include the access control attribute of the 3D object that may enable access to the virtual object session on a plurality of devices (display devices). FIG. 2D illustrate an exemplary representation depicting elements involved in access control in a virtual/augmented reality environment, according to an example embodiment of the present disclosure. The processor 102 (of FIG. 1B) may include a sub-system or access control module 206 (as shown in FIG. 2D) that may facilitate to control one or more aspects of the access on the plurality of devices. As illustrated in FIG. 2D, the access control module 206 may include sub-modules for various elements that may be associated with the access control function. In an example embodiment, the access control module 206 may include a sub-module for functions, such as, for example, creator access, user/guest access, encryption, decryption, cloud access, login and signup, continuity and storage. The access control module 206 may thus enable to resolve existing challenges in traditional augmented reality systems, which is majorly devoid of an access control system due to challenges in effective authentication of people in virtual/augmented reality. The traditional augmented reality systems may only function on passwords or links via email, which may not offer a good user experience. However, the access control module 206 may facilitate effective and reliable authentication in virtual/augmented reality by techniques such as, for example, eye tracking, hand gestures, and other such methods. In an example embodiment, the access control module 206 may include an authentication manager that may keep track of all logins and signups events. For example, the authentication manager may also enable various levels of controls to allow creator access, user access and guest access. In another example embodiment, the access control module 206 may also allow personal information such as meta data, device information and preferences to be encrypted and saved on a cloud platform. The other unique functions of the access control module 206 may include the “continuity” function wherein for a session in a XR zone on a first display device of a user, the module 206 may enable continuation of the session on a second display device of the same user without interrupting the session. For example, when a user changes from one device to another device say from HoloLens to Magic Leap, the system would be able to pause at Hololens and exactly continue at Magic Leap device.

In an example embodiment, another important attribute for adapting XR zone to provision contextually aware information includes ambisonic awareness. The ambisonic awareness based attributes may enable adjustment of the XR zone based on at least one of audio/video parameters, intended context of the environment, and desired ambience for the XR zone. FIG. 2E illustrate an exemplary representation 208 depicting elements pertaining to ambisonic awareness in a virtual/augmented reality environment, according to an example embodiment of the present disclosure. The processor 102 (of FIG. 1B) may include a sub-system or ambisonic awareness module 208 (as shown in FIG. 2E) that may facilitate to control one or more aspects of ambisonic awareness. As illustrated in FIG. 2E, the ambisonic awareness module 208 may include sub-modules for various elements that may be associated with the access control function. In an example embodiment, the ambisonic awareness module 208 may include a sub-module for functions, such as, for example, microphone access, conversations, on device machine learning (ML), different types of sound, interruptions and messages. For example, the ambisonic awareness module 208 may control the microphone access (of the display device) so as to ensure that audio data is not shared outside the device without permission from the user. In another example, the ambisonic awareness module 208 may enable to on-board ML model to execute continuously for understanding the audio data from the user to provide context for improving logical context of session. The ambisonic awareness module 208 may also enable to pre-train the ML model to identify common sounds such as, for example, environment noise, weather sounds, emergency sounds interface sounds and other sounds. Based on the identified sounds, the sub-modules of the ambisonic awareness module 208 may enable control or optimization of sounds based on requirements of a scene and/or may perform actions based on the identified sounds. For example, if the ambisonic awareness module 208 may detect a high pitched sound or phrase that use critical words such as, for example, “stop”, “save me”, the ambisonic awareness module 208 may understand and accordingly pause the experience and asks the user to step out of the XR zone to see the real world. Further, the ambisonic awareness module 208 may also include sub-modules for identifying second or third person based interruptions. The sub-modules may ensure that real world individuals are respected while use of virtual/augmented reality. For example, when a second person may come near the user wearing a virtual/augmented reality device, the ambisonic awareness module 208 may assess the same and may display a specific preview, such as, for example, guardian system view in the XR zone to the user, while requesting the user to interrupt the use of the virtual/augmented reality device. Other sub-modules may enable interface controls, wherein the user may be provided complete controls of the interface, thereby enabling to control sensing of event occurrence. Other sub-modules may also allow the user to set a Do-Not-Disturb (DND) mode. For example, if the user desires to be on a session for a specific time period (such as 1 hour) for a virtual business meeting, the user can enable a mode called Do Not Disturb that may pause all notifications and sounds on the display device outside the application. Other sub-modules also allow a user to customize/control aspects of image/video, color, darkness and other such aspects. Several other sub-modules or features may be present.

Another important attribute may include throughput of data that pertains to one or aspects of the display device/network to which the display device is connected. FIG. 2F illustrate an exemplary representation 210 depicting elements that influence throughput of data in a virtual/augmented reality environment, according to an example embodiment of the present disclosure. The processor 102 (of FIG. 1B) may include a sub-system or throughput of data module 210 (as shown in FIG. 2F) that may facilitate to control one or more aspects of the access on the plurality of devices. As illustrated in FIG. 2F, the throughput of data module 210 may include sub-modules for various elements that may be associated with the display device/network. In an example embodiment, the throughput of data may be managed based on factors such as, for example, internet speed, no. of request that can be handled by the display device, the processing load and other such factors. This sub-module mainly analyses the limit of the device and/or network. For example, any electronic device may include a processing limit such that if the device reaches a point where the number of processes being executed reach a limit, then the throughput of data module 210 may attempt to stop the processes that may be unnecessary and/or tedious/time-consuming. In this case, if the module 210 may not be able to perform this function then the system may prompt the user to inform that the maximum capacity of the user device has reached and therefore there may be a need to close some running applications. The throughput of data module 210 may include sub-module pertaining a control system for prevention of input system use by distributed denial of service (DDOS) in certain scenarios wherein the input system is being not used appropriately. For example, in controller based or hand tracking based input system for virtual/augmented reality, the system always checks if the input is given properly or not otherwise the module 210 may prevent misbehaving of user interface.

Another important attribute may include throughput of data that pertains to one or aspects of the human interaction handoff. FIG. 2G illustrate an exemplary representation 212 depicting elements associated with human interaction in a virtual/augmented reality environment, according to an example embodiment of the present disclosure. The processor 102 (of FIG. 1B) may include a sub-system or human interaction module 212 (as shown in FIG. 2G) that may facilitate to control one or more aspects of the access on the plurality of devices. As illustrated in FIG. 2G, the human interaction module 212 may include sub-modules for various elements that may be associated with the human interaction handoff for a smooth execution of access and/or sharing functions. For example, these elements may pertain to identity of the user, sensing of other individuals in real world in the vicinity of the user, and other interaction based on sharing access. Regarding the identity of the user, the human interaction module 212 may be able to establish an identity of the user based on one or more descriptive aspects of the user. For example, initially, in a virtual/augmented scene, the human interaction module 212 may be able to evaluate who the user is and/or other characteristics of the user such as, for example, height of user, length of arms and other such characteristics. In an example embodiment, this type of data may be solely read only from the internal storage, thereby limiting sharing of personal information with network, which ensures better security and effective handling of privacy concerns. The human interaction module 212 may also enable other users to participate and/or view any activity in the XR zone. As in case of an augmented reality experience, multiple users may have common experiences/scenes and may need to exchange information and data with each other. For example, while playing a game or in a virtual/augmented reality, a user may share what he/she is doing with close friends and spectators. This may be enabled by the human interaction module 212 through a sharing access. The system may thus enable a second user (known to the user) to view the experience of the user as a spectator. In another example, if a third person (unknown person) may come close to the user, the system may enable controlled access to the third user based on how much information the user may desire to share. In an example embodiment, the sharing access may be enabled through multiple modes such as, for example, one time sharing, streaming mode (that may be immersive), quick share experience and spatial share (such as two way interaction in social media applications).

Another important attribute may include throughput of data that pertains to one or aspects of the component behaviour. FIG. 2H illustrate an exemplary representation 214 depicting elements associated with component behaviour in a virtual/augmented reality environment, according to an example embodiment of the present disclosure. The processor 102 (of FIG. 1B) may include a sub-system or component behaviour module 214 (as shown in FIG. 2H) that may facilitate to control one or more aspects related control of component behaviour. As illustrated in FIG. 2H, the component behaviour module 214 may include sub-modules for various elements that may be associated with enabling user controls. For example, the sub-modules may facilitate to control the elements such as, for example, blur index, background color, user interface (UI) control, control of dark/light mode, background environment, UI texture, speed of motion associated with UI transitions (such as slow/fast motion), disabling of (or enabling) animations and other post processing features related to user controls. For example, the sub-modules of the component behaviour module 214 may be directed towards controlling blur index as a blurred background may not be desirable to users. In another example, the control of dark/light mode may also customized as preferred by the user. Similarly, the users can also choose their preferred image/video for the background environment. The component behaviour module 214 may also facilitate UI control such as, for example, the user may be able to choose a desirable material for UI such as glass, wood and other such materials. Various other settings/user controls may be enabled by this module.

Other attributes that may be crucial to govern the virtual features, data, and objects in the XR zone may include fonts, spatial awareness and locomotion. The fonts may pertain to properties of text being displayed in the virtual/augmented reality This attribute may be crucial as readability of fonts on virtual/augmented reality may be very complicated task during rendering. FIG. 2I illustrate an exemplary representation 216 depicting elements pertaining to fonts in a virtual/augmented reality environment, according to an example embodiment of the present disclosure. The processor 102 (of FIG. 1B) may include a sub-system or fonts module 216 (as shown in FIG. 2I) that may facilitate to control one or more aspects related to fonts. As illustrated in FIG. 2I, the fonts module 216 may include sub-modules for various elements that may be associated with the fonts. For example, the sub-modules may facilitate to control the elements such as, for example, font style, font color, font language and other aspects such as anti-aliasing. The term anti-aliasing may refer to digital graphics processing technique that may facilitate to smoothen lines/boundaries and also to reduce visual distortions in a scene. The anti-aliasing (and also other aspects such as anisotropy) may negatively impact the performance and reliability of the system. In an example embodiment, a machine learning (ML) based technique may be used for anti-aliasing. Other scenarios may include element related to font color, for example, white text may be displayed onto a white background that may impact visibility of the displayed text. In this case, the fonts module 216 may enable to change or suggest changes of the background to a different color (darker color) so that the displayed text is clearly readable. Several other such examples may be valid with reference to font size, style, language and other font related properties.

Another important attribute as mentioned hereinabove may be spatial awareness. This may be an important attribute from a perspective of a user and may eliminate the need for re-mapping an earlier visited scene of a user environment. This means that if a user may be visiting a place for a second time, the system may be able to understand context automatically such that corresponding scene may be loaded based on mapping information stored in local storage or cloud storage. This may lead to responsive behaviour in terms of spatial awareness. In an example embodiment, the user may be able to decide preferences for local or cloud storage. FIG. 2J illustrate an exemplary representation 218 depicting elements associated with spatial awareness in a virtual/augmented reality environment, according to an example embodiment of the present disclosure. The processor 102 (of FIG. 1B) may include a sub-system or spatial awareness module 218 (as shown in FIG. 2J) that may facilitate to control one or more aspects related to spatial awareness. As illustrated in FIG. 2J, the spatial awareness module 218 may include sub-modules for various elements that may enable to collect information associated with spatial awareness of the system. For example, the sub-modules may facilitate to control the elements pertaining to information such as, for example, Global Positioning System (GPS) data, time data, zone context, patterns, amount of light, information of human/individuals in vicinity and object awareness. The amount of light may be controlled to avoid undesirable lighting conditions (such as light intensity) in the XR zone as it may hinder tracking of the environment. In this case, the spatial awareness module 218 may alert/suggest/perform reduction of light intensity once it reaches a pre-defined threshold value. The spatial awareness module 218 may also enable to configure the UI to match an actual user environment with an experience in the augmented reality (XR zone) based on data such as the GPS data and time data. For example, in case if it is morning, sunny and outdoor conditions in the real-world user environment, the UI may be configured in shades of black for improving visibility and in case of dark conditions, bright colors may be used. The element pertaining to object awareness and humans nearby may enable to alert the user about objects and individuals respectively in the vicinity so as to avoid collision. The spatial awareness module 218 may thus guide the user with necessary alerts and notifications for avoiding contact with an object/individual within a movement space to ensure better safety of the user.

Another important attribute as mentioned hereinabove may be related to locomotion. This may be an important attribute as it may customize a locomotion type or teleportation type based on preference of the user. FIG. 2K illustrate an exemplary representation 220 depicting elements related to locomotion requirements for rendering objects in a virtual/augmented reality environment, according to an example embodiment of the present disclosure. The processor 102 (of FIG. 1B) may include a sub-system or locomotion module 220 (as shown in FIG. 2K) that may facilitate to control one or more aspects related to spatial awareness. As illustrated in FIG. 2K, the locomotion module 220 may include sub-modules for various elements that may enable to understand locomotion or teleportation preferences of a user in virtual/augmented reality environment. For example, the sub-modules may facilitate to control the elements pertaining to various types of locomotion such as, for, example, sudden jumps and teleportation. This may include involvement of jumps, teleporting based on maps, portals, and other such locomotion aspects. However, all users may not be comfortable with the nature of locomotion and may feel motion sickness or nausea in some cases. To avoid this, the locomotion module 220 may enable the user to customize locomotion preferences as per corresponding inputs from the user. Several other modules may be associated with the system.

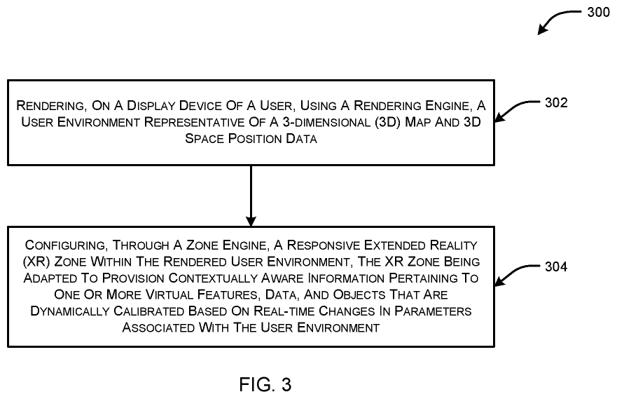

FIG. 3 illustrates a flow diagram 300 depicting steps involved in rendering objects in a virtual/augmented reality environment, according to an example embodiment of the present disclosure. At 302, the method includes a step of rendering a user environment representative of a 3-Dimensional (3D) map and 3D space position data. The user environment may be rendered using a rendering engine and may be displayed on a display device of a user. At 304, the method includes a step of configuring a responsive extended reality (XR) zone within the rendered user environment. The XR zone may be configured through a zone engine. The XR zone may be adapted to provision contextually aware information pertaining to one or more virtual features, data, and objects that may be dynamically calibrated based on real-time changes in parameters associated with the user environment. In an example embodiment, the calibration may be performed with respect to at least one of sizing, representation, and visualization in a responsive manner. The XR zone may include at least one virtual object, and may be associated with a space within the user environment that defines boundary of the space. The at least one virtual object may be presented to the user by one or more real world environmental points of interest. In an example embodiment, the at least one virtual object may be selected by the user based on one or more real environmental features. The behaviour of the at least one virtual object with respect to at least one of dimension, properties, and attributes, may be controlled by a criteria set by the zone engine. In an example embodiment, multiple XR zones may be configured within the user environment. The virtual features, the data, and the objects in the XR zone may be governed based on attributes comprises at least one of object dimensioning, object resolution, active field of view, ambisonic awareness, throughput of the data, access control of the object, human interaction handoff, and component behaviour. The object dimensioning based attributes may enable positioning of 3D objects in a spatial interaction medium with suitable adjustments to size the objects for efficient viewing. The object resolution based attributes may enable adjustment of resolution of the 3D objects based on bandwidth availability. The active field of view based attributes adjust desired field of view based on at least one of size of the user environment, actual field of view, meshes that are visible to camera, and memory parameters. The ambisonic awareness based attributes enable adjustment of the XR zone based on at least one of audio/video parameters, intended context of the environment, and desired ambience for the XR zone. The access control of the object may enable access to the virtual object session on a plurality of devices.

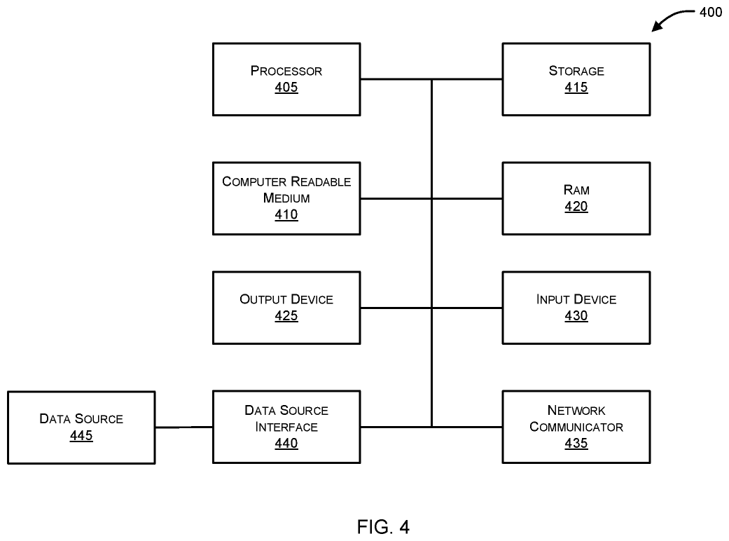

FIG. 4 illustrates a hardware platform 400 for implementation of the disclosed system, according to an example embodiment of the present disclosure. For the sake of brevity, construction and operational features of the system 110/computing device 100, which are explained in detail above are not explained in detail herein. Particularly, computing machines such as but not limited to internal/external server clusters, quantum computers, desktops, laptops, smartphones, tablets, and wearables which may be used to execute the system 100 or may include the structure of the hardware platform 400. As illustrated, the hardware platform 400 may include additional components not shown, and that some of the components described may be removed and/or modified. For example, a computer system with multiple GPUs may be located on external-cloud platforms including Amazon Web Services, or internal corporate cloud computing clusters, or organizational computing resources, etc.

The hardware platform 400 may be a computer system such as the system 100 that may be used with the embodiments described herein. The computer system may represent a computational platform that includes components that may be in a server or another computer system. The computer system may execute, by the processor 405 (e.g., a single or multiple processors) or other hardware processing circuit, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor 405 that executes software instructions or code stored on a non-transitory computer-readable storage medium 410 to perform methods of the present disclosure. The software code includes, for example, instructions to configure the XR zone. In an example, the rendering engine 104, the zone engine 106 and other modules/sub-modules described may be software codes or components performing these steps.

The instructions on the computer-readable storage medium 410 are read and stored the instructions in storage 415 or in random access memory (RAM). The storage 415 may provide a space for keeping static data where at least some instructions could be stored for later execution. The stored instructions may be further compiled to generate other representations of the instructions and dynamically stored in the RAM such as RAM 420. The processor 405 may read instructions from the RAM 420 and perform actions as instructed.

The computer system may further include the output device 425 to provide at least some of the results of the execution as output including, but not limited to, visual information to users, such as external agents. The output device 425 may include a display on display devices and virtual/augmented reality glasses of the user. For example, the display may be a mobile phone screen or a laptop screen. GUIs and/or text may be presented as an output on the display screen. The computer system may further include an input device 430 to provide a user or another device with mechanisms for entering data and/or otherwise interact with the computer system. The input device 430 may include, for example, a keyboard, a keypad, a mouse, or a touchscreen. Each of these output device 425 and input device 430 may be joined by one or more additional peripherals. For example, the output device 425 may be used to display rendered user environment and/or configured XR zone that is generated by the system.

A network communicator 435 may be provided to connect the computer system to a network and in turn to other devices connected to the network including other clients, servers, data stores, and interfaces, for instance. A network communicator 435 may include, for example, a network adapter such as a LAN adapter or a wireless adapter. The computer system may include a data sources interface 440 to access the data source 445. The data source 445 may be an information resource. As an example, a database of exceptions and rules may be provided as the data source 445. Moreover, knowledge repositories and curated data may be other examples of the data source 445.

Thus, the present disclosure provides a system and method enable to generate a responsive rendering technique for virtual/augmented reality based on changes in real environment of a user. The system and method may generate extended reality zones that can be dynamically calibrated based on real time changes for an enriched user experience. The system and method includes contextual awareness that can provide a frame-work for defining 2D content representations that can be utilized into 3D spatial data and objects in an XR zone/environment. The present technique may also enable calibration of objects in the XR zone/environment based on sizing, representation, and visualization in a responsive manner.

One of ordinary skill in the art will appreciate that techniques consistent with the present disclosure are applicable in other contexts as well without departing from the scope of the disclosure.

What has been described and illustrated herein are examples of the present disclosure. The terms, descriptions, and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

I/We claim:

1. A method for rendering objects in a virtual/augmented reality environment, comprising:
rendering, on a display device of a user, using a rendering engine, a user environment representative of a 3-Dimensional (3D) map and 3D space position data; and
configuring, through a zone engine, a responsive extended reality (XR) zone within the rendered user environment, the XR zone being adapted to provision contextually aware information pertaining to one or more virtual features, data, and objects that are dynamically calibrated based on real-time changes in parameters associated with the user environment.

2. The method as claimed in claim 1, wherein the calibration is performed with respect to at least one of sizing, representation, and visualization in a responsive manner.

3. The method as claimed in claim 1, wherein the XR zone comprises at least one virtual object, and is associated with a space within the user environment that defines boundary of the space, the at least one virtual object being presented to the user by one or more real world environmental points of interest.

4. The method as claimed in claim 3, wherein the at least one virtual object is selected by the user based on one or more real environmental features.

5. The method as claimed in claim 3, wherein behaviour of the at least one virtual object with respect to at least one of dimension, properties, and attributes, is controlled by a criteria set by the zone engine.

6. The method as claimed in claim 1, wherein multiple XR zones are configured within the user environment.

7. The method as claimed in claim 1, wherein the virtual features, the data, and the objects in the XR zone are governed based on attributes comprises at least one of object dimensioning, object resolution, active field of view, ambisonic awareness, throughput of the data, access control of the object, human interaction handoff, and component behaviour.

8. The method as claimed in claim 7, wherein the object dimensioning based attributes enable positioning of 3D objects in a spatial interaction medium with suitable adjustments to size the objects for efficient viewing, and wherein the object resolution based attributes enable adjustment of resolution of the 3D objects based on bandwidth availability.

9. The method as claimed in claim 7, wherein the active field of view based attributes adjust desired field of view based on at least one of size of the user environment, actual field of view, meshes that are visible to camera, and memory parameters, and wherein the ambisonic awareness based attributes enable adjustment of the XR zone based on at least one of audio/video parameters, intended context of the environment, and desired ambience for the XR zone.

10. The method as claimed in claim 7, wherein the access control of the object enables access to a virtual object session on a plurality of devices.

11. A system for rendering objects in a virtual/augmented reality environment, the system comprising
a processor;
a memory comprising a set of instructions, which when executed, cause the processor to:
render, on a display device of a user, using a rendering engine, a user environment representative of a 3-Dimensional (3D) map and 3D space position data; and
configure, through a zone engine, a responsive extended reality (XR) zone within the rendered user environment, the XR zone being adapted to provision contextually aware information pertaining to one or more virtual features, data, and objects that are dynamically calibrated based on real-time changes in parameters associated with the user environment.

12. The system as claimed in claim 11, wherein the calibration is performed with respect to at least one of sizing, representation, and visualization in a responsive manner.

13. The system as claimed in claim 11, wherein the XR zone comprises at least one virtual object, and is associated with a space within the user environment that defines boundary of the space, the at least one virtual object being presented to a user by one or more real world environmental points of interest.

14. The system as claimed in claim 13, wherein the at least one virtual object is selected by the user based on one or more real environmental features.

15. The system as claimed in claim 13, wherein behaviour of the at least one virtual object with respect to at least one of dimension, properties, and attributes, is controlled by criteria set by the zone engine.

16. The system as claimed in claim 11, wherein multiple XR zones are configured within the user environment.

17. The system as claimed in claim 11, wherein the virtual features, the data, and the objects in the XR zone are governed based on attributes selected from at least one of object dimensioning, object resolution, active field of view, ambisonic awareness, throughput of the data, access control of the object, human interaction handoff, and component behaviour.

18. The system as claimed in claim 17, wherein the object dimensioning based attributes enable positioning of 3D objects in a spatial interaction medium with suitable adjustments to size the objects for efficient viewing, and wherein the object resolution based attributes enable adjustment of resolution of the 3D objects based on bandwidth availability.

19. The system as claimed in claim 17, wherein the active field of view based attributes adjust desired field of view based on at least one of a size of the user environment, actual field of view, meshes that are visible to camera, and memory parameters, and wherein the ambisonic awareness based attributes enable adjustment of the XR zone based on at least one of audio/video parameters, intended context of the environment, and desired ambience for the XR zone.

20. The system as claimed in claim 17, wherein the access control of the object enables access to a virtual object session on a plurality of devices.
